(19) United States
(12) Patent Application Publication
(10) Pub. No.: US 2012/0308216 A1
(43) Pub. Date: Dec. 6, 2012

(54) HEATING APPARATUS

(76) Inventor: Donald William BRYCE, Natick, MA (US)

(21) Appl. No.: 13/467,094

(22) Filed: May 9, 2012

Related U.S. Application Data
(60) Provisional application No. 61/492,405, filed on Jun. 2, 2011.

(51) Int. Cl. H05B 1/00; F24H 3/00; H05B 1/02

(52) U.S. Cl. 392/422; 219/537; 219/480

(57) ABSTRACT

An electrical heating apparatus includes a stationary housing having a lower base portion, an upper control portion, and a column portion extending from and rigidly connecting the base and control portions. The base and control portions define first and second parallel and horizontally spaced-apart vertical housing axes, and the control portion includes control circuitry and first and second direction controllers. First and second heating units each include a radiant heating element and a reflector, the heating elements adapted upon energization to radiate heat, and the reflector disposed and adapted to reflect the radiated heat from the heating unit. The heating units each engage the base and control portions of the housing, is engaged by one of the direction controller, and has a pivot axis disposed coaxial with and pivotable about one of the housing axes.

### RELATED APPLICATION

This application is a Continuation and Formalization of U.S. Provisional Application Ser. No. 61/492,405 filed on Jun. 2, 2011, the entire teachings of which are hereby incorporated herein by reference.

### FIELD OF THE INVENTION

The present invention is generally related to household heaters, and more specifically to portable electric heaters for most effectively and most efficiently providing heat to one or more portions of a room.

### BACKGROUND OF THE INVENTION

There is an ongoing need to obtain localized heating at home and in the work place. Portable electric heaters have become a common tool for providing heat to a room, to thereby avoid the expense and inefficiencies associated with heating an entire home. As energy costs rise and incomes fall in a declining economy, the need to obtain maximum comfort from each BTU of heat produced by such heaters is ever more important. Homes in which only certain rooms are typically used, and by only one or two persons, are particularly vulnerable to wasted energy and expense.

Certain electrical air heaters include the ability to focus heat toward a person and thereby minimize the waste of energy heating elsewhere when only one person is present. The Room Heater disclosed in U.S. Pat. No. 3,051,820 and numerous similar radiant heaters since are such heaters which employ one or more quartz heating tubes each surrounded by a parabolic reflector to focus heat waves and direct them from the heating element into a narrow beam so that the energy produced by the element can be directed at a single user. However, such heaters are not capable of providing focused heat to multiple separated users or to multiple and variable locations in a room simultaneously. Neither are such heaters capable of independent control of a plurality of differently directed heating units.

Certain fan-forced electrical air heaters include the ability to direct heated airflows towards two areas. The Pivotable Heater disclosed in U.S. Pat. No. 6,321,034, and numerous similar heaters since, includes two stacked heating units, one atop the other, sharing a common vertical pivot axis such that each unit may be directed independently, allowing one heating unit to aim its heated airflow in one direction and the other heating unit to aim its heated airflow in a second direction. However, such fan-forced heaters are not adapted to provide focused heating as would be most effective and efficient for heating two separated persons. The fan-forced airflow dispersed from each unit is turbulent and not focused. It is better adapted to heating an air space than a person. Even if such an arrangement was, hypothetically, somehow capable of focusing its two heat streams, the stacked configuration would cause the streams to aim at differing heights. One person's feet would be warmed while the other's head would be warmed, but neither person would realize an optimal heating experience.

There exists the need for a heating appliance which is capable of directing focused heating energy at either one or two persons, and such is an object of the present invention.

There exists the need for a heating appliance which is capable of directing focused heating energy at two persons along the same horizontal plane, and such is an object of the present invention.

There exists the need for a heating appliance which is capable of directing focused heating energy in a plurality of directions simultaneously, and such is an object of the present invention.

There exists the need for a heating appliance which is capable of directing a pair of focused heat streams separated by a selectably variable angle, and such is an object of the present invention.

There exists the need for such heating appliances having independent controllability, and such is an object of the invention.

Other needs and objects will become apparent upon a reading of the following disclosure in combination with the appended drawings.

### SUMMARY OF THE INVENTION

The invention may be embodied in an electric heater having a pair of side-by-side heating units which are selectively adaptable to operate together as a single heater, both focusing their heat energy in the same direction, or as two independently operable heating units, each focusing its heat stream in a different direction along the same horizontal plane and each capable of independent operation and direction.

The invention may be practiced in an electrical heating apparatus having a stationary housing defining first and second parallel and horizontally spaced-apart vertical housing axes, a first heating unit engaging the housing and having a first pivot axis disposed coaxial with the first housing axis and pivotable thereabout, and a second heating unit engaging the housing and having a second pivot axis disposed coaxial with the second housing axis and pivotable thereabout.

The first heating unit may be pivotable independently of the second heating unit. The housing may have first and second direction controllers engaging and adapted to cause pivoting of the first and second heating units respectively. The housing may further include electrical control circuitry for controlling the heating operation of the first and second heating units. The electrical control circuitry may include power control circuitry for energizing and controlling a power level of operation of the first and second heating units.

The power control circuitry may include first and second switches for independently controlling the power level of operation of the first and second heating units respectively. The electrical control circuitry may include thermostatic control circuitry for selecting an ambient temperature range of operation of the first and second heating units.

The first and second heating units may each include a heating element and a reflector, each heating element adapted upon energization by the control circuitry to radiate heat, and each reflector disposed and adapted to reflect the radiated heat from the heating unit. The heating elements may be elongate quartz heating tubes. The quartz heating tubes may each be disposed coaxial with one of the first and second pivot axes.

The invention may also be practiced in an electrical heating apparatus having a stationary housing defining first and second parallel and horizontally spaced-apart vertical housing axes and an oscillation control, a first heating unit engaging the housing and having a first oscillation axis disposed coaxial with the first housing axis and oscillatable thereabout by the oscillation control, and a second heating unit engaging the housing and having a second oscillation axis disposed coaxial with the second housing axis and oscillatable thereabout by the oscillation control.

The first heating unit may be oscillatable independently of the second heating unit. The housing may include electrical control circuitry for controlling the heating operation of the first and second heating units. The electrical control circuitry may include power control circuitry for energizing and controlling a power level of operation of the first and second heating units.

The power control circuitry may include first and second switches for independently controlling the power level of operation of the first and second heating units respectively. The electrical control circuitry may include thermostatic control circuitry for selecting an ambient temperature range of operation of the first and second heating units.

The first and second heating units may each include a heating element and a reflector, each heating element adapted upon energization by the control circuitry to radiate heat, and each reflector disposed and adapted to reflect the radiated heat from the heating unit. The heating elements may be elongate quartz heating tubes. The quartz heating tubes may each be disposed coaxial with one of the first and second oscillation axes.

The invention may also be practiced in an electrical heating apparatus having a stationary housing with a lower base portion, an upper control portion, and a column portion extending from and rigidly connecting the base and control portions. The base and control portions may define first and second parallel and horizontally spaced-apart vertical housing axes, and the control portion may include control circuitry and first and second direction controllers. The apparatus may include a first heating unit comprising a first heating element and a first reflector, the first heating element adapted upon energization to radiate heat, and the first reflector disposed and adapted to reflect the radiated heat from the first heating unit, the first heating unit engaging the base and control portions of the housing, engaged by the first direction controller, and having a first pivot axis disposed coaxial with the first housing axis and pivotable thereabout. The apparatus may also include and a second heating unit comprising a second heating element and a second reflector, the second heating element adapted upon energization to radiate heat, and the second reflector disposed and adapted to reflect the radiated heat from the second heating unit, the second heating unit engaging the base and control portions of the housing, engaged by the second direction controller, and having a second pivot axis disposed coaxial with the second housing axis and pivotable thereabout.

Electrical control circuitry may be included within the control portion of the housing for controlling the heating operation of the first and second heating units, the circuitry including power control circuitry for energizing and independently controlling a power level of operation of the first and second heating units.

Further features and aspects of the invention are disclosed with more specificity in the Detailed Description and Drawings of an exemplary embodiment provided herein.

### BRIEF DESCRIPTION OF THE DRAWINGS

Many aspects of the invention can be better understood with reference to the following drawings showing the representative embodiment of the accompanying Detailed Description. The components in the drawings are not necessarily to scale, emphasis instead being placed upon clearly illustrating the principles of the invention. Moreover, in the drawings, like reference numerals designate corresponding parts throughout the several views.

FIG. 1 is a perspective view of a portable electric heater in accordance with a first exemplary embodiment of the invention;

FIG. 2 is a cross-sectional view of the heater of FIG. 1;

FIG. 3 is a front view of the heater of FIG. 1 with its two heating units directed forwardly;

FIG. 4 is a top view of the heater of FIG. 1 with its two heating units directed forwardly;

FIG. 5 is a front view of the heater of FIG. 1 with its left heating unit directed forwardly and its right heating unit directed rightwardly;

FIG. 6 is a top view of the heater of FIG. 1 with its left heating unit directed forwardly and its right heating unit directed rightwardly;

FIG. 7 is a front view of the heater of FIG. 1 with its right heating unit directed forwardly and its left heating unit directed leftwardly;

FIG. 8 is a top view of the heater of FIG. 1 with its right heating unit directed forwardly and its left heating unit directed leftwardly;

FIG. 9 is a front view of the heater of FIG. 1 with its right heating unit directed rightwardly and its left heating unit directed leftwardly;

FIG. 10 is a top view of the heater of FIG. 1 with its right heating unit directed rightwardly and its left heating unit directed leftwardly;

FIG. 11 is a schematic top view of a reflector/heating element combination of the heater of FIG. 1;

FIG. 12 is a simplified cross-sectional top view the heater of FIG. 1 with its two heating units directed forwardly;

FIG. 13 is a simplified cross-sectional top view the heater of FIG. 1 with its left heating unit directed forwardly and its right heating unit directed rightwardly;

FIG. 14 is a simplified cross-sectional top view the heater of FIG. 1 with its right heating unit directed forwardly and its left heating unit directed leftwardly; and

FIG. 15 is a simplified cross-sectional top view the heater of FIG. 1 with its two heating units directed slightly convergent.

### DETAILED DESCRIPTION OF SEVERAL REPRESENTATIVE EMBODIMENTS

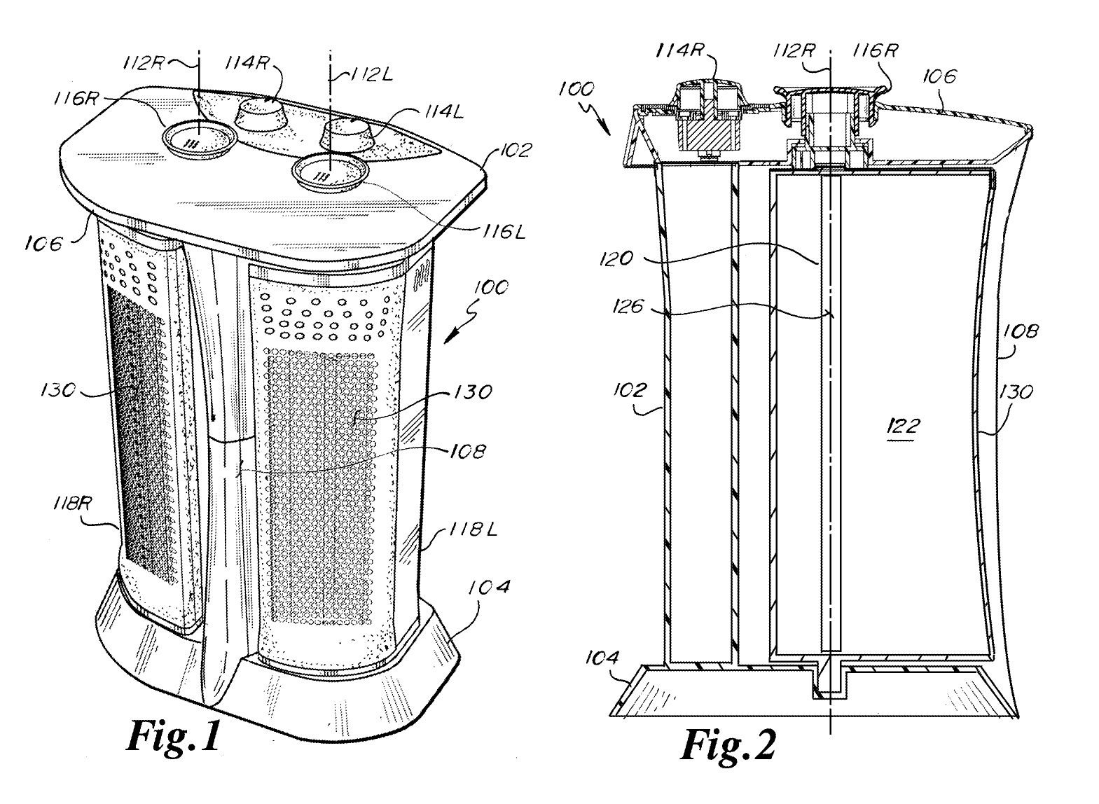

Referring to FIGS. 1 through 15, a heating apparatus 100 is depicted which includes a stationary housing 102 having a lower base portion 104, an upper control portion 106, and a column portion 108 extending from and rigidly connecting the base and control portions. The base and control portions define first and second parallel and horizontally spaced-apart vertical housing axes, left housing axis 112L and right housing axis 112R, and the control portion includes control circuitry including left and right control switches 114L and 114R, and first and second direction controllers, 116L and 116R.

First and second heating units 118L and 118R each include a tubular quartz radiant heating element 120 and a metallic reflector 122, the heating elements adapted upon energization to radiate heat, and the reflector disposed and adapted to reflect the radiated heat from the associated heating unit. The heating units each engage the base and control portions of the housing, at bottom pivots 124 and at the upper pivotable engagement to the associated direction controller. Each unit has a pivot axis 126 that is disposed coaxial with and pivotable about one of the housing axes.

The heating units are each electrically connected to and controlled by the control circuitry so that each heating element can be independently energized and its power level can be selectively adjusted according to the position of its associated control switch 128L or 128R. In an alternate embodiment not shown, an adjustable thermostatic control allows energization of both heating elements only when the ambient room temperature falls below a selected level.

Each heating unit includes a perforated protective front grill 130 to prevent persons or objects from inadvertently toughing the heating elements. The grills are sufficiently perforated to cause no substantial interference with heating energy from the unit.

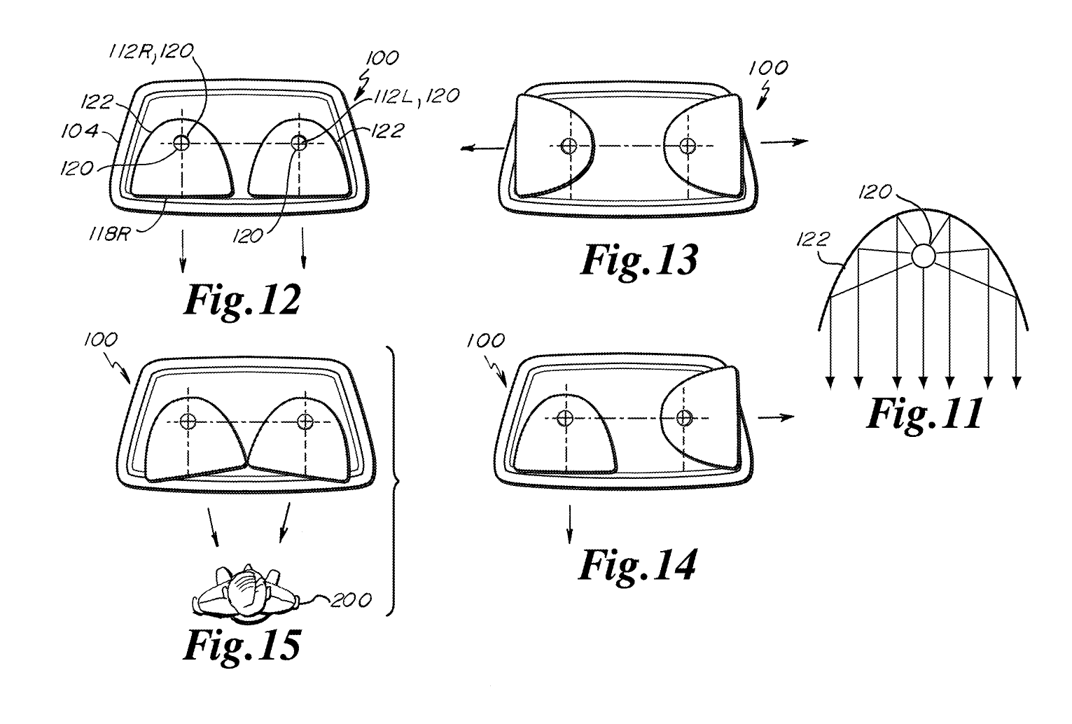

Referring to FIG. 11, it can be seen how reflector 122 is parabolically shaped to redirect heat waves from heating element 120 and focus the rays forwardly from the heating unit. It is a useful quality of such a purely radiant heating system that the rays will travel through the air devoid of any substantial turbulence and only cause heating when their energy impacts an object, such as a person. This allows for the efficient use the heating energy by avoiding the waste of heating the air between the heater and the object, and allows for the focusing of substantially all of the heating energy at the object. In comparison, fan forced heaters heat the air within a heating unit and force that heated air turbulently out into the room, wasting most of the heating energy to heat air that the occupants of the room may never sense, and directing the heating energy at objects and areas that may have no need therefore.

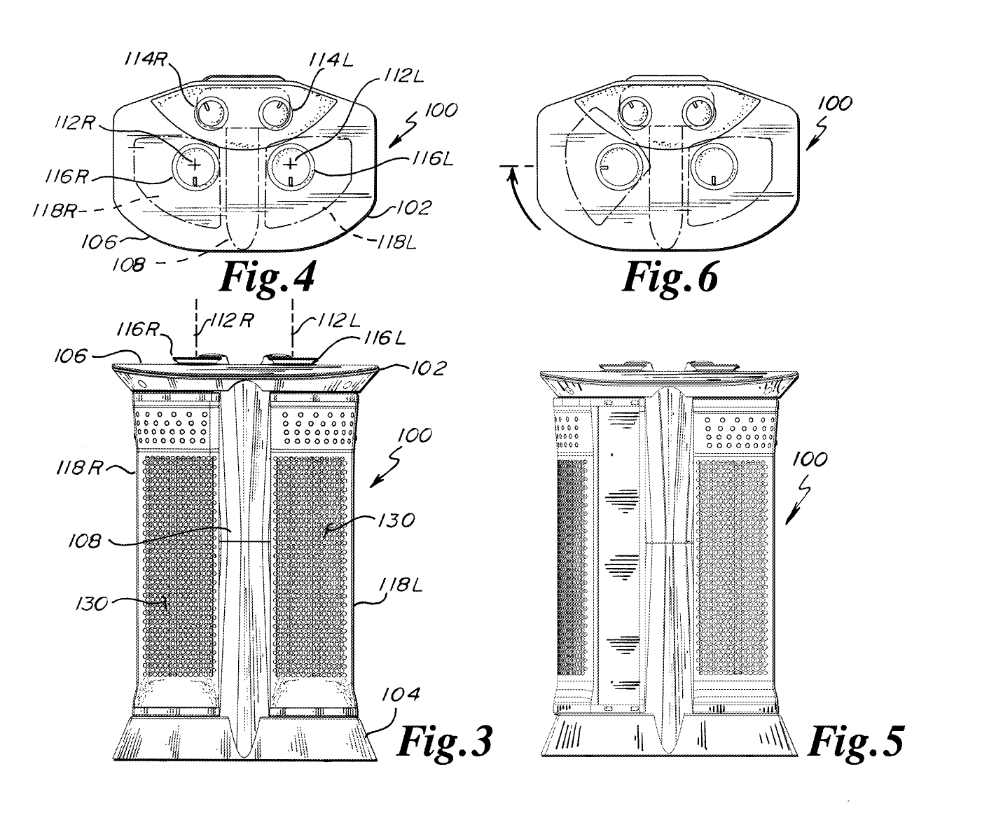

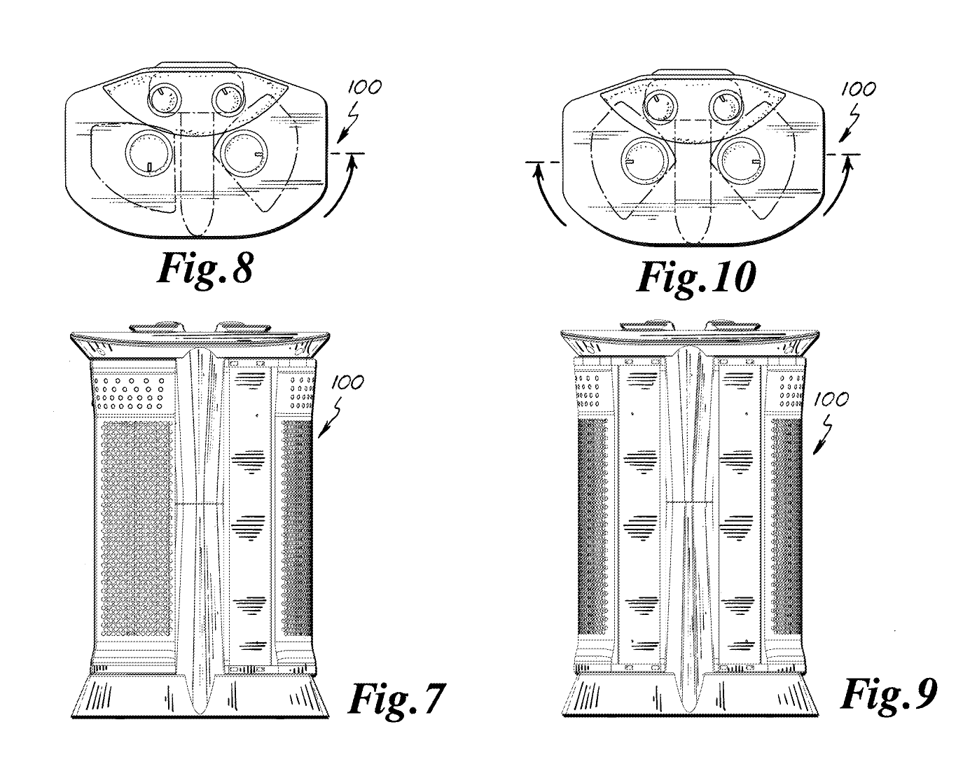

Referring to FIGS. 3 through 10 and 12 through 15, it can be seen that the rotation of either or both of the direction controllers 116L and 116R causes pivoting of the associated heating unit 118L and 118R, respectively, so that heating energy may be directed towards any two of an infinite possible directions within the room. In FIGS. 3 and 4 the heating units are both directed forwardly, as would be preferred for aiming all of the heating energy at one person, or say two persons sitting together. In FIGS. 5 and 6, the right heating unit 118R is directed rightwardly while the left heating unit 118L remains forwardly directed. In FIGS. 7 and 8, the left heating unit 118L is directed leftwardly while the right heating unit 118R remains forwardly directed. In FIGS. 9 and 10, the left heating unit 118L is directed leftwardly while the right heating unit 118R is directed rightwardly.

Referring to FIGS. 12 through 15, it can be seen that the heating elements of the exemplary embodiment are coaxially disposed on the vertical housing axes and pivot axes. This feature maintains the heating elements effectively stationary as the reflectors are rotated relative thereto during redirection. Among other advantages, this substantially eliminates flexure stress on the wiring connecting the heating elements.

FIG. 15 shows that the heating units may be directed into a slightly divergent position to even better focus their heating energy at a single person 200.

In another anticipated alternate embodiment of the invention not shown, the heating units are physically connected to the control portion through an oscillation mechanism including an oscillation motor. Energization of the oscillation motor causes the heating units to pivot back and forth in an oscillating motion to sweep their heating element across the room. The heating units may be connected to the oscillation motor by any common type of linkage or gearing. A clutch mechanism allows the user to forcibly pivot the heating units relative to each other and relative to the oscillation mechanism so that the synchronicity and starting/stopping angles of each heating unit may be altered. For instance, the right unit may be caused to point rightwardly whenever the left unit is pointing forwardly, and vice versa, or the both units may be caused to point simultaneously outwardly and simultaneously forwardly, according to the desired heating effect. Since such an oscillation mechanism and such a clutching system would be a matter of routine design, the invention is not to be limited by the specific structure of each.

While the invention has been shown and described with reference to specific exemplary embodiments, it should be understood by those skilled in the art that various changes may be made thereto without sacrificing its material advantages. Various changes in form and detail may be made without departing from the spirit and scope of the invention, and the invention should therefore only be limited according to the following claims, including all equivalent interpretation to which they are entitled.

I claim:

1. An electrical heating apparatus comprising:
a stationary housing defining first and second parallel and horizontally spaced-apart vertical housing axes;
a first heating unit engaging the housing and having a first pivot axis disposed coaxial with the first housing axis and pivotable thereabout; and
a second heating unit engaging the housing and having a second pivot axis disposed coaxial with the second housing axis and pivotable thereabout.

2. The electrical heating apparatus of claim 1 wherein the first heating unit is pivotable independently of the second heating unit.

3. The electrical heating apparatus of claim 2 wherein the housing comprises first and second direction controllers engaging and adapted to cause pivoting of the first and second heating units respectively.

4. The electrical heating apparatus of claim 3 wherein the housing further comprises electrical control circuitry for controlling the heating operation of the first and second heating units.

5. The electrical heating apparatus of claim 4 wherein the electrical control circuitry comprises power control circuitry for energizing and controlling a power level of operation of the first and second heating units.

6. The electrical heating apparatus of claim 5 wherein the power control circuitry comprises first and second switches for independently controlling the power level of operation of the first and second heating units respectively.

7. The electrical heating apparatus of claim 6 wherein the electrical control circuitry comprises thermostatic control circuitry for selecting an ambient temperature range of operation of the first and second heating units.

8. The electrical heating apparatus of claim 7 wherein the first and second heating units each comprise a heating element and a reflector, each heating element adapted upon energization by the control circuitry to radiate heat, and each reflector disposed and adapted to reflect the radiated heat from the heating unit.

9. The electrical heating apparatus of claim 8 wherein the heating elements are elongate quartz heating tubes.

10. The electrical heating apparatus of claim 9 wherein the quartz heating tubes are each disposed coaxial with one of the first and second pivot axes.

11. An electrical heating apparatus comprising:
a stationary housing defining first and second parallel and horizontally spaced-apart vertical housing axes and an oscillation control;
a first heating unit engaging the housing and having a first oscillation axis disposed coaxial with the first housing axis and oscillatable thereabout by the oscillation control; and
a second heating unit engaging the housing and having a second oscillation axis disposed coaxial with the second housing axis and oscillatable thereabout by the oscillation control.

12. The electrical heating apparatus of claim 11 wherein the first heating unit is oscillatable independently of the second heating unit.

13. The electrical heating apparatus of claim 12 wherein the housing further comprises electrical control circuitry for controlling the heating operation of the first and second heating units.

14. The electrical heating apparatus of claim 13 wherein the electrical control circuitry comprises power control circuitry for energizing and controlling a power level of operation of the first and second heating units.

15. The electrical heating apparatus of claim 14 wherein the power control circuitry comprises first and second switches for independently controlling the power level of operation of the first and second heating units respectively.

16. The electrical heating apparatus of claim 15 wherein the electrical control circuitry comprises thermostatic control circuitry for selecting an ambient temperature range of operation of the first and second heating units.

17. The electrical heating apparatus of claim 16 wherein the first and second heating units each comprise a heating element and a reflector, each heating element adapted upon energization by the control circuitry to radiate heat, and each reflector disposed and adapted to reflect the radiated heat from the heating unit.

18. The electrical heating apparatus of claim 17 wherein the heating elements are elongate quartz heating tubes.

19. The electrical heating apparatus of claim 18 wherein the quartz heating tubes are each disposed coaxial with one of the first and second oscillation axes.

20. An electrical heating apparatus comprising;
a stationary housing comprising a lower base portion, an upper control portion, and a column portion extending from and rigidly connecting the base and control portions; the base and control portions defining first and second parallel and horizontally spaced-apart vertical housing axes, and the control portion comprising control circuitry and first and second direction controllers;
a first heating unit comprising a first heating element and a first reflector, the first heating element adapted upon energization to radiate heat, and the first reflector disposed and adapted to reflect the radiated heat from the first heating unit, the first heating unit engaging the base and control portions of the housing, engaged by the first direction controller, and having a first pivot axis disposed coaxial with the first housing axis and pivotable thereabout; and
a second heating unit comprising a second heating element and a second reflector, the second heating element adapted upon energization to radiate heat, and the second reflector disposed and adapted to reflect the radiated heat from the second heating unit, the second heating unit engaging the base and control portions of the housing, engaged by the second direction controller, and having a second pivot axis disposed coaxial with the second housing axis and pivotable thereabout;
electrical control circuitry within the control portion of the housing for controlling the heating operation of the first and second heating units comprising power control circuitry for energizing and independently controlling a power level of operation of the first and second heating units.
